(19) United States
(12) Patent Application Publication
(10) Pub. No.: US 2010/0315816 A1
(43) Pub. Date: Dec. 16, 2010

(54) RING LIGHT DIFFUSER

(75) Inventor: Robin James Edward Madelin, Helensville (NZ)

Correspondence Address: LOGINOV & ASSOCIATES, PLLC, 10 WATER STREET, CONCORD, NH, 03301, US

(73) Assignee: ENLIGHT PHOTO LTD, Parnell, AU (NZ)

(21) Appl. No.: 12/740,775

(22) PCT Filed: Oct. 31, 2008
(86) PCT No.: PCT/NZ2008/000291

§ 371 Date: Apr. 30, 2010

(30) Foreign Application Priority Data
Nov. 1, 2007 (NZ) 563064
Feb. 11, 2008 (NZ) 565888

(51) Int. Cl. F21V 7/00

(52) U.S. Cl. 362/294; 362/296.01

(57) ABSTRACT

A light reflector is disclosed for use in a photographic ring light diffuser. The light reflector consists of a substantially circular body including an outer wall having an opening therein for the provision of a light source, an inner wall provided substantially about a substantially circular aperture at or adjacent the centre of the rear panel. The inner surfaces of the body are substantially reflective, thereby reflecting light from the light source uniformly at an angle substantially coaxial with the aperture. Also disclosed is an adapter for coupling a light source with the light reflector, and a ring light diffuser including the same.

### FIELD

This invention relates to an artificial lighting device for a still or video camera. More particularly, the invention relates to an improved ring light or ring flash, including an adapter for coupling the diffuser with a light source.

### BACKGROUND

In photography, an electronic flash unit, commonly known simply as a flash or strobe, is an instantaneous artificial light source used to illuminate a subject at relatively short range. The flash is often detachably fixed to the camera by a standardised accessory mount bracket; an adapter coupled with a matching adapter provided on the top of the camera, known as a hot shoe, thereby providing the camera with means to activate the flash. Alternatively, other flash synchronisation methods may be used, most commonly if the flash is provided as a standalone unit. The flash may be powered by either the camera or, more commonly, an auxiliary power source such as a battery or batteries provided within the flash unit or a separate power source attached to the flash, in the case of studio flash systems.

Also known are constant light sources which may be used for still photography, but are more commonly used in conjunction with a video camera.

A common problem with such flashes is that the flash or light source is often displaced from the optical axis of the camera, casting a shadow. This is particularly troublesome where the photographer lacks the technical expertise to control the shadows to avoid their position and other factors having a negative impact on the image.

In order to overcome this problem, photographers may use what is known as a ring light or ring flash, in which the light source is provided about the camera lens. This circular light source may consist of a plurality of individual light sources, such as flash tubes or light emitting diodes. A ring light or flash provides an even illumination of the subject from the optical axis of the camera, as the light surrounds the axis.

Also known are ring flash diffusers which have no light source of their own, but instead redirect the light from a standard flash unit or light source to a ring-shaped diffuser provided at the end of the camera lens. However, such ring flash or light diffusers have disadvantages including, but not limited to, being inconvenient to use, not being particularly effective at reflecting light from the flash or light source towards the subject, not being suitable for use with an external light source, and/or having an attachment means which is insufficient or unsuitable for attaching an external light source to the reflector.

U.S. Pat. No. 4,085,436 to Allen Weiss, for example, discloses the use of clamping members for securing the flash unit to a ring light converter. These clamping members include a clamping screw which is inconvenient to use, and which may cause damage to the flash unit if over-tightened.

U.S. Pat. No. 6,430,371 to Cho, U.S. Pat. No. 7,127,163 to Junwon Lee et al., and International Publication No. WO04081648 to van Zetten each discloses a diffuser which is secured relative to the camera lens such that an input face or aperture is substantially adjacent to a light source built into the camera, thus having a known position, and being adapted to redirect light incident thereupon such that it is reflected about, and parallel with, the optical axis of the camera. These diffusers are therefore not suitable for use with an external light source.

International Publication No. WO07006241 to Zyka discloses a circular device which may be attached to an external flash which is mounted to the camera, and therefore may be limited in the light sources with which it may be associated, and may not conveniently be held in position by the photographer.

### OBJECT OF THE INVENTION

It is therefore an object of the invention to provide a ring light diffuser which overcomes or ameliorates at least one disadvantage of the prior art. Alternatively, it is an object of the present invention to at least provide the public with a useful choice.

Further objects of the invention will become apparent from the following description.

### SUMMARY OF INVENTION

Accordingly in one aspect the invention may broadly be said to consist in an adapter for coupling a ring light diffuser with a light source, including two or more opposing flexible gripping members inwardly biased from a base portion for gripping the light source therebetween.

Preferably the flexibility of each gripping member is provided by an arcuate connecting member between the gripping member and the base portion.

Preferably the gripping members are adapted to engage with a range of light sources having varying dimensions.

Preferably the base portion includes an engagement means for detachably engaging the adapter with a ring light diffuser.

Preferably the engagement means is in the form of a clip slidably and releasably engageable with the ring light diffuser.

Alternatively the base portion may be formed integrally with a ring light diffuser.

Preferably the adapter is formed substantially from a material having relatively high tensile and flexural strength and resistance to fatigue.

Preferably the material is plastic.

Preferably the plastic material is acetal, ABS, or an ABS/polycarbonate mix.

Preferably at least one of the gripping members is provided with an angled lip to facilitate insertion of a light source between opposing gripping members.

Preferably the adapter includes one or more alignment members adapted to squarely align the adapter such that the light source is secured substantially parallel to the base portion.

According to a further aspect, the invention can broadly be said to consist in a ring light diffuser including, or adapted to engage with, an adapter according to any one of the preceding statements.

According to a further aspect, the invention can broadly be said to consist in a light reflector for use in a ring light diffuser, the light reflector consisting of a body including an outer wall provided about the circumference of a rear panel of the reflector and having an opening therein for the provision of a light source, an inner wall provided substantially about a substantially circular aperture at or adjacent the centre of the rear panel, the inner surfaces of the body being substantially reflective, thereby reflecting light from the light source uniformly at an angle substantially coaxial with the aperture.

Preferably the light reflector includes one or more arcuate fins provided circumferentially about the aperture, spaced apart from the inner and outer walls to direct light from the opening about the aperture.

Alternatively, the light reflector may include a plurality of substantially planar fins provided about the aperture and adapted to reflect light about the aperture.

Preferably the inner wall is tapered towards the opening in the outer wall, thereby directing light from the opening about the aperture.

Preferably at least a portion of the rear panel is at a substantially acute angle relative to the angle of incidence of light from the opening.

Preferably said portion of the rear panel is substantially towards the side of the reflector opposing the opening.

Preferably the light reflector is formed from vacuum-metalised plastic.

Alternatively, or additionally, the light reflector may be formed from mirror styrene, electroplated plastic, polished aluminium, or a combination thereof.

Preferably when formed from mirror styrene the light reflector is formed from a mirror styrene sheet, punched and over-formed to encapsulate the fins.

Preferably the light reflector includes a light diffusion means to diffuse reflected light.

Preferably the light diffusion means is in the form of a substantially transparent diffusing lens.

Preferably the diffusion of the lens is graduated, whereby the lens is most diffusive substantially adjacent said light source and relatively less diffusive towards an opposing side of said diffusing lens.

Preferably the graduated diffusion is continuous.

Alternatively the graduated diffusion comprises two or more discrete diffusive regions.

Alternatively the light diffusion means may be in the form of a diffusive reflective surface.

According to a further aspect, the invention can broadly be said to consist in a ring light diffuser including a light reflector according to any one of the preceding statements.

According to a further aspect, the invention can broadly be said to consist in a ring light diffuser including an adapter and a light reflector according to any one of the preceding statements.

According to a further aspect, the invention can broadly be said to consist in a ring light diffuser including:
a light reflector for use in a ring light diffuser, the light reflector consisting of a body including an outer wall provided about the circumference of a rear panel of the reflector and having an opening therein for the provision of a light source, an inner wall provided substantially about a substantially circular aperture at or adjacent the centre of the rear panel, the inner surfaces of the body being substantially reflective, thereby reflecting light from the light source uniformly at an angle substantially coaxial with the aperture; and
an adapter for coupling the ring light diffuser, with the light source at or adjacent said opening, including two or more opposing gripping members inwardly biased from a base portion for gripping the light source therebetween.

Further aspects of the invention, which should be considered in all its novel aspects, will become apparent from the following description.

### DRAWING DESCRIPTION

A number of embodiments of the invention will now be described by way of example with reference to the drawings in which:

FIG. 1 is a side elevation of a first embodiment of an adapter for coupling a ring light diffuser with a light source according to the invention.

FIG. 2 is an isometric view of the adapter of FIG. 1.

FIG. 3 is a third angle projection of an embodiment of a light reflector for use in a ring light diffuser according to the invention.

FIG. 4 is an isometric view of the reflector of FIG. 3.

FIG. 5 is an exploded isometric view of a ring light diffuser according to one embodiment of the invention.

FIG. 6 is an isometric view of the embodiment of FIG. 5.

FIG. 7 is a side elevation of one embodiment of a ring light diffuser according to the invention in use, shown attached to a camera and a flash unit.

FIG. 8 is a front elevation of the embodiment of FIG. 5, again shown in use.

FIG. 9 is a front elevation of an embodiment of the invention including a graduated diffusing lens, shown in use.

### DETAILED DESCRIPTION OF THE DRAWINGS

Throughout the description like reference numerals will be used to refer to like features in different embodiments. Where reference is made herein to a ring light diffuser or a light source, these terms are intended to include within their scope a ring flash diffuser and a flash unit, respectively. It will be appreciated that the invention has application to both still photograph cameras and video cameras, either digital or analogue.

Broadly speaking the invention can be said to consist in an ring light diffuser (hereinafter ‘diffuser’) adapter for coupling the diffuser with a light source.

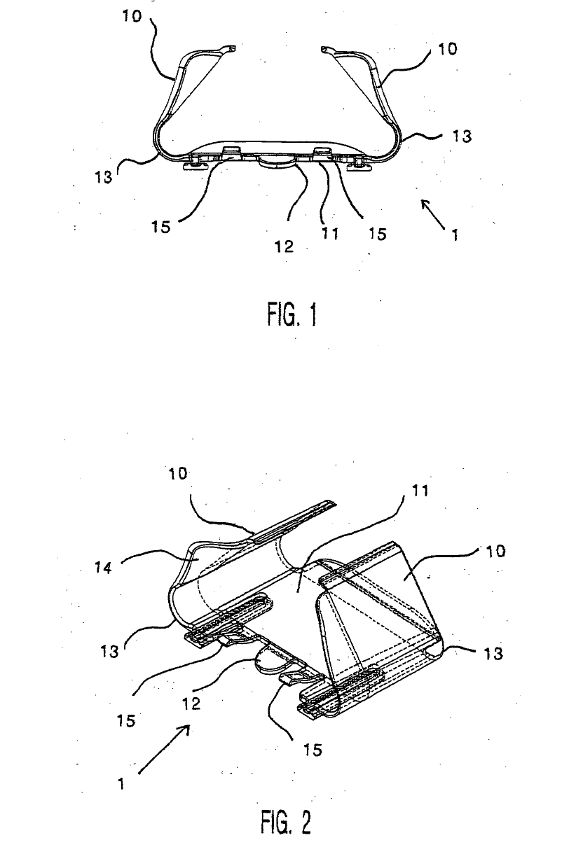

Referring first to FIGS. 1 and 2, one possible embodiment of a ring light diffuser adapter (hereinafter ‘adapter’) according to the invention is shown generally referenced 1. The adapter consists of two or more opposing gripping members 10 adapted to grasp a light source such as an electronic flash or strobe unit. The gripping members 10 are spaced apart by a base portion 11 of the adapter.

The gripping members 10 have at least some degree of flexibility and are inwardly biased, thereby permitting the insertion and gripping of the light source by flexing the gripping members 10 outwardly to accommodate the light source. The range of light source dimensions which may be held by the adapter and the pressure applied by the gripping members 10 may be changed by altering the flexibility of the material and/or design of the adapter 1.

The adapter 1 is preferably formed from a rigid material having relatively high tensile and flexural strength and resistance to fatigue, such as acetal, ABS, or an ABS/polycarbonate mix. The flexibility of each gripping member 10 is preferably provided by way of at least one arcuate connecting member 13 provided between the base portion 11 and said gripping member 10.

As illustrated in the embodiment of FIG. 2, at least one of the gripping members 10 preferably includes an angled lip 14 to facilitate insertion of the light source between opposed gripping members 10. Sliding the light source between the gripping members 10 causes the arcuate connecting members 13 and or gripping members 10 to flex, parting the gripping members 10 as the light source is inserted past the lip 14. Inward biasing of the gripping members 10 causes a gripping action therebetween to retain the light source in the adapter 1.

The adapter 1 may be integrally formed with a diffuser, or preferably provided with some form of engagement means 12 whereby the adapter can be removably attached to the ring light diffuser. This permits removal of the adapter 1 from the diffuser for easier engagement with the light source. The embodiments of FIGS. 1 and 2 show the engagement means 12 in the form of a spring clip slidably engageable with a complementary engagement means provided on the diffuser. This embodiment further includes a pair of alignment members 15 adapted to squarely align the adapter 1 by accommodating the protruding lip or ridge commonly found on or towards the front edge of a light source, such that the light source is secured substantially parallel to the base portion 11.

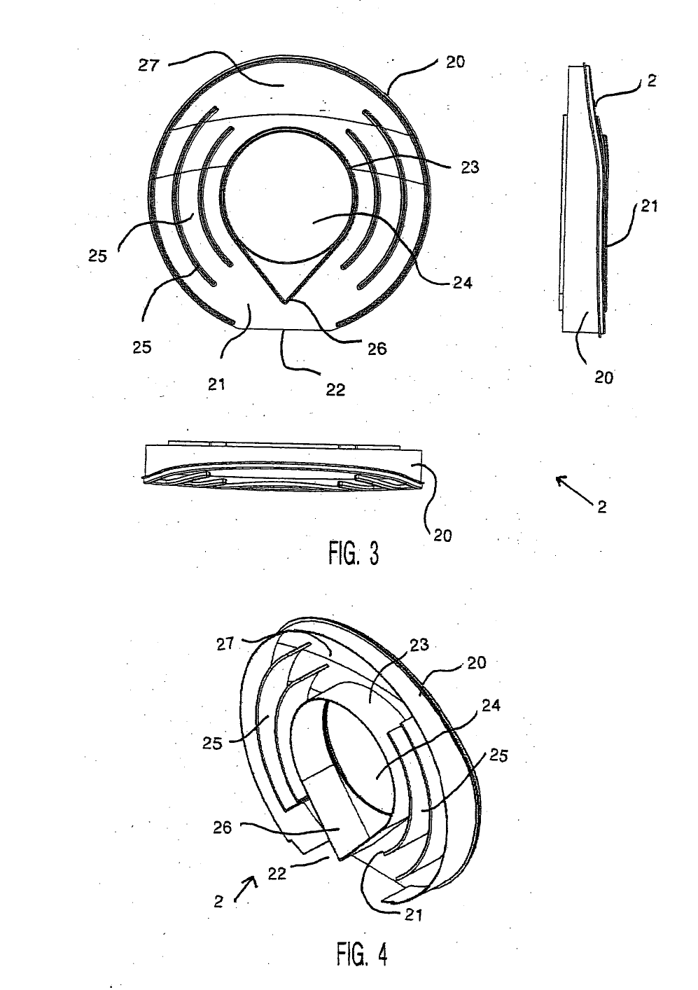

According to a further embodiment, the invention consists in a light reflector for use in a ring light diffuser provided about a camera lens. Referring to FIGS. 3 and 4, one embodiment of a light reflector (hereinafter ‘reflector’) according to the invention is shown generally referenced 2. In this embodiment, the reflector 2 consists of a rear panel 21 having an aperture 24 in approximately the centre to accommodate a camera lens therethrough.

An outer wall 20 is preferably provided circumferentially about the periphery of the rear panel 21 and includes an opening 22 for the provision of a light source. The light source is intended to be provided such that the angle of incidence of light is substantially orthogonal to the axis of the aperture 24 and therefore the optical axis of the camera.

Provided about the aperture 24 is an inner wall 23. As shown in the illustrated embodiment, the inner wall 23 preferably has a tapered end 26 towards the centre of the opening 22, thereby directing incident light about the aperture 24 by reflecting light away from the opening 22.

To further assist in directing light about the aperture to ensure uniform reflection of light, the reflector may be provided with one or more reflective arcuate fins 25, preferably parallel with the inner and outer walls, 23 and 20 respectively. Alternatively, the reflector may be provided with a plurality of substantially rectilinear fins arranged to reflect light around the aperture. Such linear reflectors may be arranged substantially orthogonally in inner and outer squares about the aperture, for example, whereby light incident upon each linear fin, initially from the opening 22, is reflected substantially orthogonally.

Furthermore, to reflect light substantially orthogonally with respect to the angle of incidence, the rear panel 21, or at least a portion 27 thereof towards a side of the rear panel 21 opposing the opening 22, may be inclined with respect to the angle of incidence, preferably at an acute angle.

The inner surfaces of the reflector 2, including the outer wall 20, rear panel 21, inner wall 23 and arcuate fins 25 are preferably reflective. It is envisioned that the reflector 2 can be made from vacuum-metalised plastic, electroplated plastic, polished aluminium or mirror styrene sheet, punched and over-formed to encapsulate the arcuate fins 25, for example.

Preferably the light reflector also includes a light diffusion means to diffuse the light reflected by the reflector 2 and avoid specular reflections. This is preferably in the form of a substantially transparent diffusing lens 31 provided in front of the reflector 2, formed from transparent polycarbonate having a textured surface, for example. Polycarbonate may be sandblasted to provide a suitable textured surface.

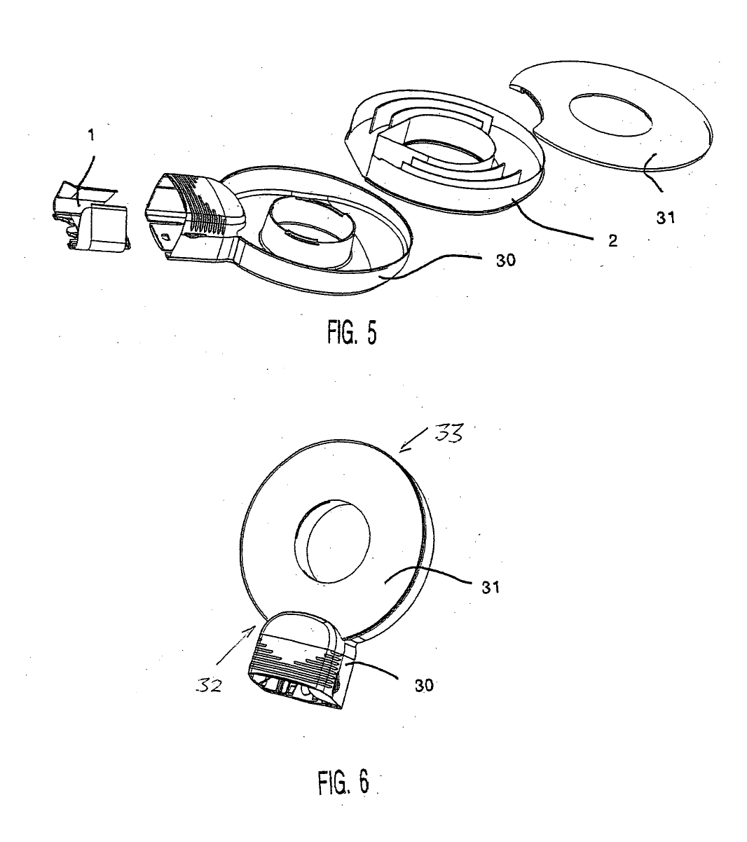

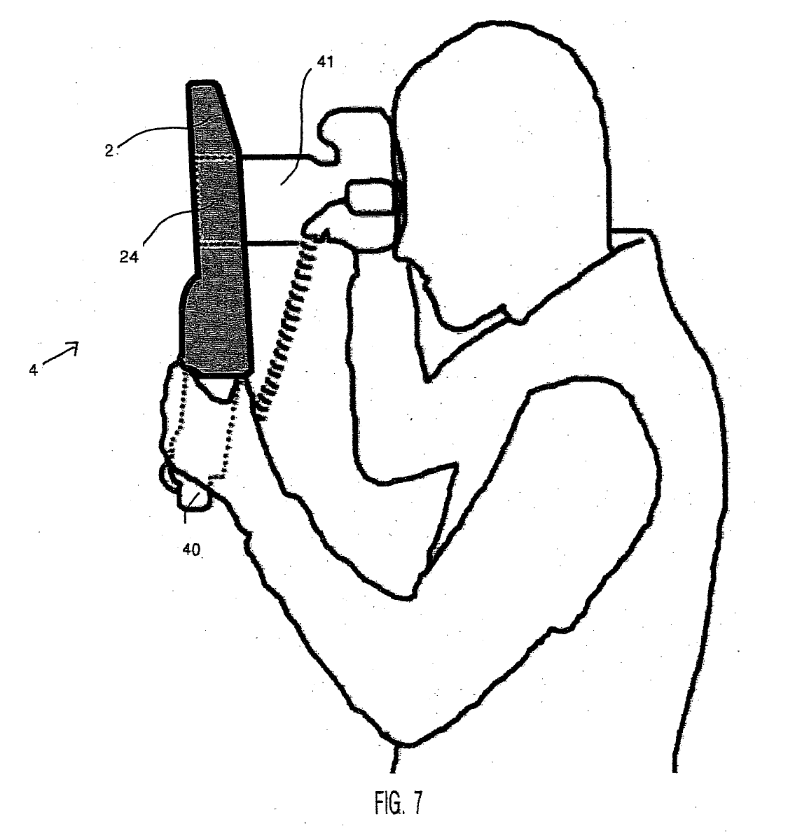

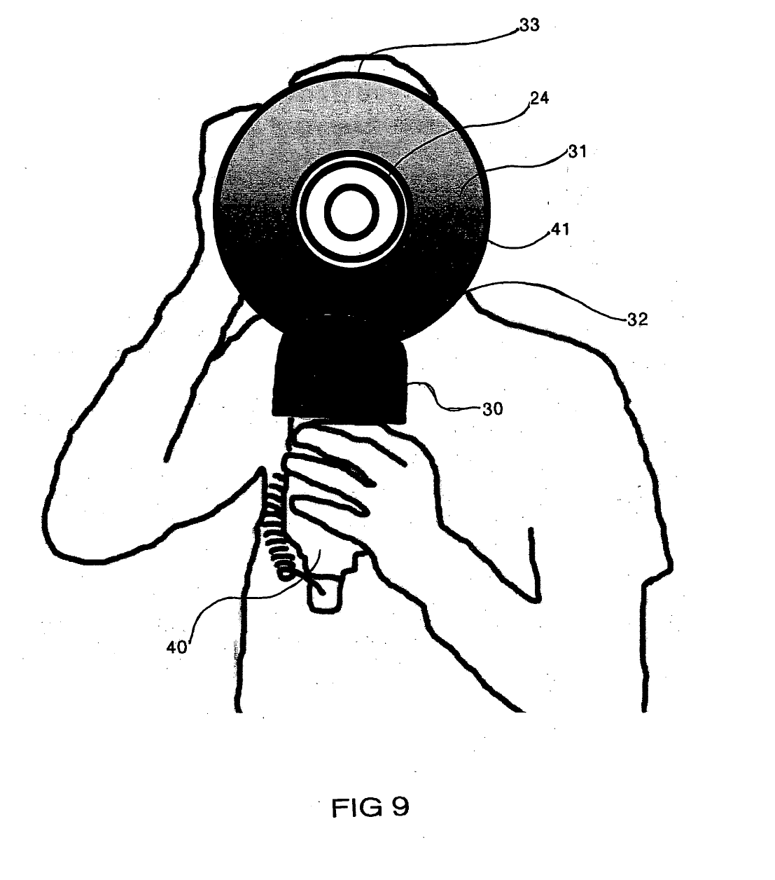

The diffusing lens 31 is preferably a graduated diffusion lens such that the lens is more diffusive in one or more regions than in others. Referring to FIG. 6, the lens is preferably graduated such that the lens provides a greater level of diffusion substantially towards a first side 32 of the lens 31 substantially adjacent the light source 40, while less diffusion occurs towards the opposing second side 33 of the lens 31, thereby providing a more even source of light from the apparatus. Ideally there is a continuous graduation of the level of diffusion as shown in FIG. 9, but it is envisioned that two or more discrete levels of diffusion may alternatively be utilised. It is also envisioned that the graduated diffusion may not necessarily be linear from the first side 32 of the lens 31 to the second side 33, but may alternatively be concentric, for example.

As an alternative to the diffusing lens 31, it is envisioned that the reflective internal surfaces of the reflector 2 may be diffusive.

It will be appreciated by those skilled in the art that the invention may also consist in a ring light diffuser including either the adapter 1 or the light reflector 2 described herein above, or a combination thereof. The reflector 2 may be provided in a housing adapted to engage with a camera lens using a screw thread, for example, or may be adapted to itself form a housing for engagement with both a light source and a camera lens. According to the preferred embodiment, however, the adapter 1 is sufficient to secure the light reflector 2 to the camera flash such that the ring light diffuser may simply be held in position about the camera lens by holding the flash unit or light source 40 in a position substantially adjacent the distal end of the camera lens and substantially orthogonal to the optical axis of the camera as shown in FIGS. 7 to 9.

Referring to FIGS. 5 and 6, an adapter 1 and reflector 2 are shown with a housing 30 and diffusing lens 31 in a preferred embodiment of the invention wherein the housing 30 is adapted to engage with the aforementioned components as described above.

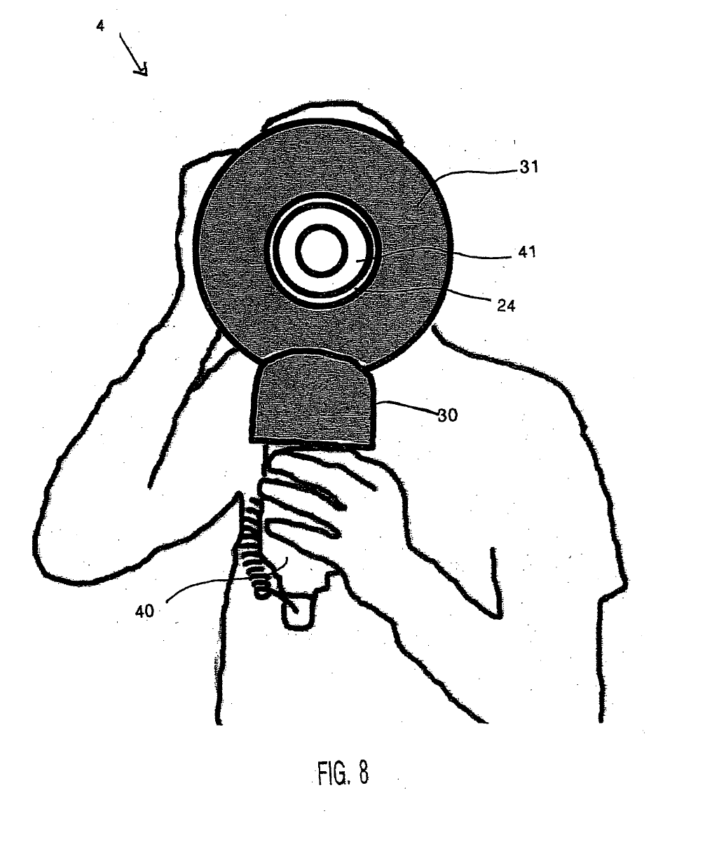

A fully assembled ring flash diffuser according to one embodiment of the invention is shown in use in FIGS. 7 and 8, generally referenced 4. The diffuser 4 engages with a light source 40 with an adapter (not shown), while the reflector 2 is positioned about the camera lens 41 which at the aperture 24. The reflector 2 deflects at least a portion of the light from the light source 40 (or a plurality of light sources) about the aperture 24 before being reflected substantially orthogonally, parallel with the optical axis of the camera lens 41, thereby providing substantially even illumination of the photograph subject.

From the foregoing it will be seen that an improved ring light diffuser is provided which offers a versatile light source adapter able to retain a wide range of external light sources of varying dimensions, and an improved light reflector for more efficiently redirecting light from one or more external light sources coaxially with the optical axis of a camera.

Although this invention has been described by way of example and with reference to possible embodiments thereof, it is to be understood that modifications or improvements may be made thereto without departing from the scope of the invention. Furthermore, where reference has been-made to specific components or integers of the invention having known equivalents, then such equivalents are herein incorporated as if individually set forth.

Any discussion of the prior art throughout the specification should in no way be considered as an admission that such prior art is widely known or forms part of common general knowledge in the field.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

1. A light reflector for use in a ring light diffuser, the light reflector comprising:
a body including an outer wall provided about the circumference of a rear panel of the reflector, the outer wall having an opening therein for the provision of a light source, an engagement element to allow a light source to be removably engaged with the body at or adjacent to opening, and an inner wall provided substantially about a substantially circular aperture at or adjacent the centre of the rear panel, the inner surfaces of the body being substantially reflective, thereby reflecting light from the opening substantially uniformly about the aperture and at an angle substantially coaxial therewith.

2. A light reflector as claimed in claim 1 wherein the light reflector includes one or more arcuate fins provided circumferentially about the aperture, spaced apart from the inner and outer walls to direct light from the opening about the aperture.

3. A light reflector as claimed in claim 1 wherein the light reflector includes a plurality of substantially planar fins provided about the aperture and adapted to reflect light about the aperture.

4. A light reflector as claimed in claim 1 wherein the inner wall is tapered towards the opening in the outer wall to reflect light incident upon the tapered portion away from the opening.

5. A light reflector as claimed in claim 1 wherein at least a portion of the rear panel is at a substantially acute angle relative to the angle of incidence of light from the opening.

6. A light reflector as claimed in claim 5 wherein said portion of the rear panel is substantially towards the side of the reflector opposing the opening.

7. A light reflector as claimed in claim 1 wherein the light reflector is formed from vacuum-metalised plastic.

8. A light reflector as claimed in claim 1, wherein the light reflector includes a lens having graduated diffusion, which is most diffusive substantially adjacent said opening and relatively less diffusive towards an opposing side of said diffusing lens.

9. (canceled)

10. (canceled)

11. A light reflector as claimed in claim 8 wherein the graduated diffusion is continuous.

12. A light reflector as claimed in claim 8 wherein the graduated diffusion comprises two or more discrete diffusive regions.

13. (canceled)

14. A ring light diffuser including a light reflector according to claim 1.

15-25. (canceled)

26. A ring light diffuser as claimed in claim 11 configured to removably receive at or adjacent the opening an adapter engageable with the light source, for coupling the light source with the ring light diffuser.

27. A ring light diffuser including:
a light reflector consisting of a body including an outer wall provided about the circumference of a rear panel of the reflector, the outer wall having an opening therein for the provision of a light source, an inner wall provided substantially about a substantially circular aperture at or adjacent the centre of the rear panel, the inner surfaces of the body being substantially reflective, thereby reflecting light from the opening substantially uniformly about the aperture at an angle substantially coaxial therewith; and
an adapter for coupling the ring light diffuser with the light source at or adjacent said opening, including at least two opposing gripping members inwardly biased from a base portion for gripping the light source therebetween.

28-30. (canceled)

31. A ring light diffuser as claimed in claim 27, wherein the adapter is removably attached to the ring light diffuser.
